(19) United States
(12) Patent Application Publication
(10) Pub. No.: US 2012/0110917 A1
(43) Pub. Date: May 10, 2012

(54) Outer Belt Molding

(75) Inventors: Haruhisa Kawase, Rochester Hills, MI (US); Peter J. Ellis, Rochester Hills, MI (US)

(73) Assignee: Magna International Inc., Aurora (CA)

(21) Appl. No.: 13/351,651

(22) Filed: Jan. 17, 2012

Related U.S. Application Data
(62) Division of application No. 11/695,662, filed on Apr. 3, 2007.
(60) Provisional application No. 60/788,831, filed on Apr. 3, 2006.

(51) Int. Cl. B60J 10/04

(52) U.S. Cl. 49/493.1

(57) ABSTRACT

An outer belt molding is provided for a motor vehicle door having a door panel defining a window opening. The outer belt molding includes an elongated main body adapted to be attached to the door panel along a lower edge of the window opening. The elongated main body includes a mounting portion including a vertical segment abutting a portion of the door panel and an outer segment extending out from the vertical segment abutting another portion of the door panel. The outer belt molding also includes fastening means extending between at least one of the outer and vertical segments and the door panel to fixedly secure the outer belt molding to the door panel.

### CROSS-REFERENCE TO RELATED APPLICATIONS

This application is a divisional application of U.S. patent application Ser. No. 11/695,662, filed on Apr. 3, 2007, which claims the benefit of U.S. Provisional Application Ser. No. 60/788,831, filed Apr. 3, 2006 and entitled “Outer Belt Molding.” All applications are incorporated herein by reference in their entireties.

### BACKGROUND OF THE INVENTION

1. Field of the Invention

The invention relates to an outer belt molding for a motor vehicle door. More particularly, the invention relates to a low profile outer belt molding for attachment to a door panel of a motor vehicle door.

2. Description of Related Art

Outer belt moldings are commonly secured along a flange that is formed along a door panel of a vehicle door. Three examples of conventional outer belt moldings are shown in FIGS. 1 through 3. In FIGS. 1 and 2, an outer belt molding 10 includes spaced apart legs 12, 14 defining a channel 16 for receiving a flange 18. One of the legs 12, 14 includes at least one retention gripper 20 for maintaining the outer belt molding 10 along the flange 18. In FIG. 3, the flange 18 is defines a door channel 22 for receiving one leg 12 including the retention grippers 20. In order for each of the above-described systems to work, however, the motor vehicle door must be bent or otherwise adapted to provide the flange 18 or channel 22 for attachment with the outer belt molding 10.

The above-described outer belt molding arrangements tend to be too tall and/or wide resulting in a larger outer belt molding that is not aesthetically pleasing. Moreover, the additional metal material that is required to create a flange for mounting by the outer belt molding adds to the weight of the door and increases manufacturing costs.

### SUMMARY OF THE INVENTION

According to one aspect of the invention, an outer belt molding is provided for a motor vehicle door having a door panel defining a window opening. The outer belt molding includes an elongated main body adapted to be attached to the door panel along a lower edge of the window opening. The elongated main body includes a mounting portion including a vertical segment abutting a portion of the door panel and an outer segment extending out from the vertical segment abutting another portion of the door panel. The outer belt molding also includes fastening means extending between at least one of the outer and vertical segments and the door panel to fixedly secure the outer belt molding to the door panel.

### BRIEF DESCRIPTION OF THE DRAWINGS

The invention will be readily appreciated as the same becomes better understood by reference to the following detailed description when considered in connection with the accompanying drawings wherein:

FIG. 1 is a sectional view of a prior art outer belt molding;

FIG. 2 is a sectional view of another prior art outer belt molding;

FIG. 3 is a sectional view of yet another prior art outer belt molding;

FIG. 4 is a side view of a motor vehicle including a door defining a window opening and an outer belt molding according to the invention disposed along a lower edge of the window opening;

FIG. 5 is a fragmentary perspective view of the outer belt molding including an elongated main body;

FIG. 6 is a sectional view of the outer belt molding including double sided tape for securing the outer belt molding to a door panel;

FIG. 7 is a sectional view of an outer belt molding according to another embodiment including a clip heat-staked to an outer segment of the elongated main body for securing the outer belt molding to the door panel;

FIG. 8 is a sectional view of an outer belt molding according to still another embodiment including a clip co-extruded with an outer segment of the elongated main body;

FIG. 9 is a sectional view of an outer belt molding according to yet another embodiment including a clip extending through a vertical segment of the elongated main body to secure the outer belt molding to the door panel;

FIG. 10 is a sectional view of an outer belt molding according to another embodiment including a clip extending through a web portion formed in the elongated main body; and

FIG. 11 is a sectional view of one more embodiment wherein the outer belt molding includes retention members for engagement with a retention tab welded to the door panel.

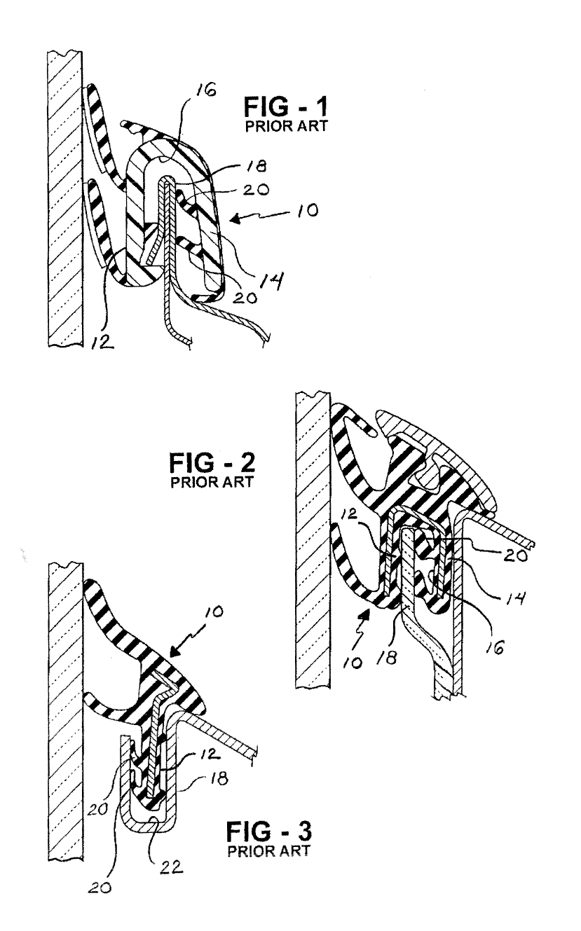

### DETAILED DESCRIPTION OF THE EMBODIMENTS

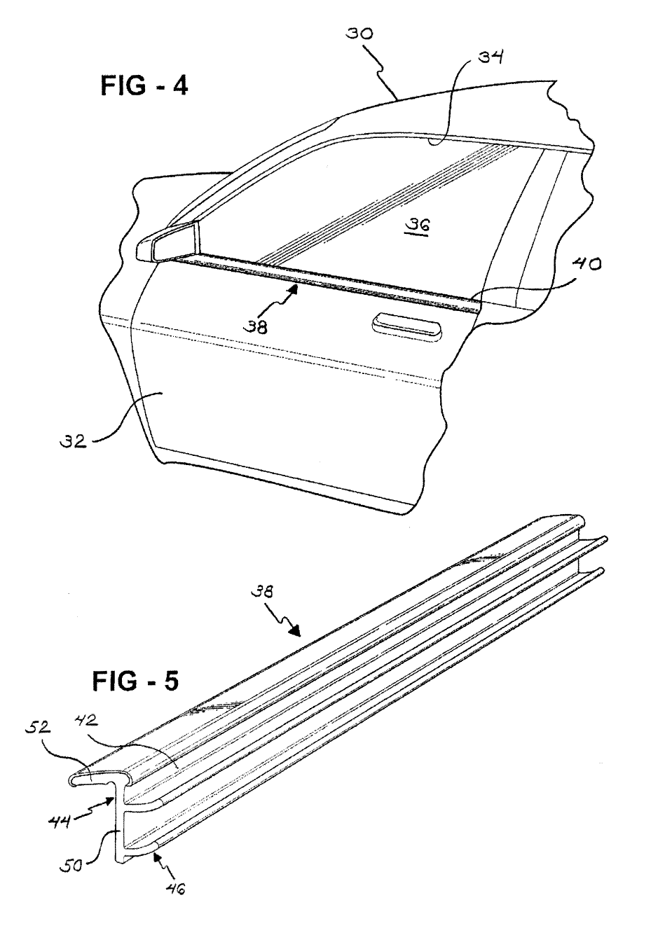

Starting with reference to FIG. 4, a motor vehicle 30 includes a door 32 defining a window opening 34. The window opening 34 is closed by a movable window pane 36. An outer belt molding, generally shown at 38, is adapted to be attached to the door 32 along a lower edge 40 of the window opening 34. The outer belt molding 38 provides a sealing engagement between the door 32 and the window pane 36 to prevent moisture from passing through the window opening 34.

Referring to FIG. 5, the outer belt molding 38 includes an elongated main body 42 adapted to extend along the lower edge 40 of the window opening 34. The main body 42 may be formed from polypropylene or TPO. It is, however, appreciated that the main body 42 may be formed from any of numerous moldable materials. The main body 42 includes a mounting portion 44 and a sealing portion 46.

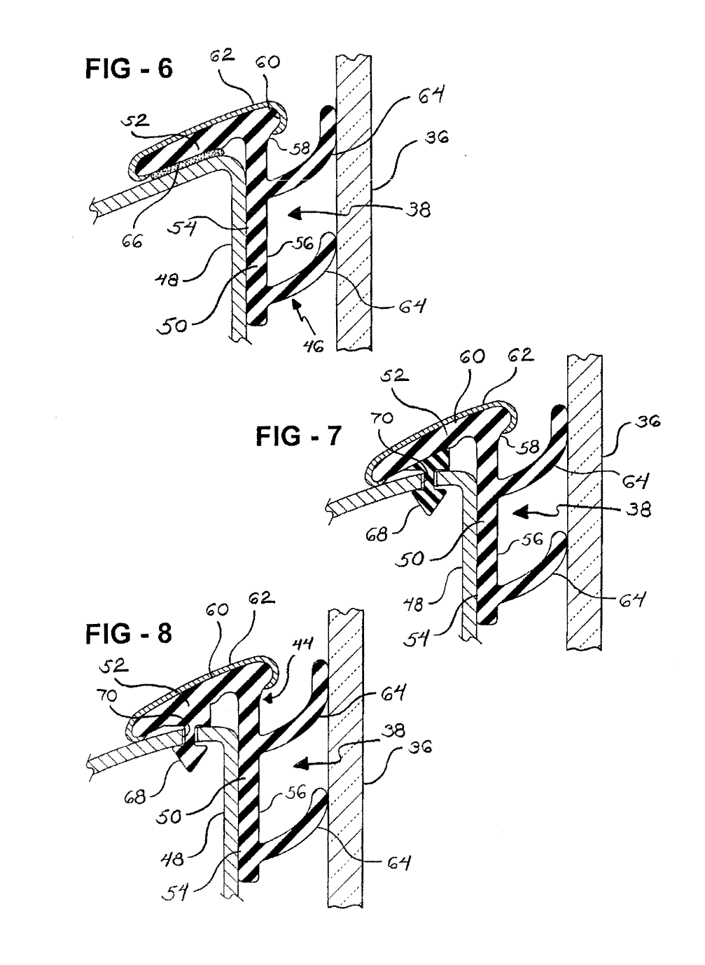

Referring to FIG. 6, the mounting portion 44 abuts a door panel 48 of the door 32. The mounting portion 44 includes a generally vertical segment 50 and an outer segment 52 extending out therefrom. The vertical segment 50 includes a door panel surface 54 and an opposing window facing surface 56. The outer segment 52 extends out from an upper end 58 of the vertical segment 50 and rests along a portion of the door panel 48. The outer segment 52 includes an outboard surface 60 that is disposed along a visible external surface of the door 32. A decorative trim 62 is fixedly secured along the outboard surface 60 of the outer segment 52. The decorative trim 62 may be any of numerous materials, such as TPE, selected to complement the overall appearance of the door 32.

The sealing portion 46 includes a plurality of closeout lips 64 extending out from the window facing surface 56 of the vertical segment 50. The plurality of closeout lips 64 sealingly engages the window panes 35, 36. The plurality of closeout lips 64 may be formed from any of numerous materials including TPV or the like.

The outer belt molding 38 further includes a fastener 66 positioned between the main body 44 and the door panel 48 to fixedly secure the outer belt molding 38 thereto. In FIG. 6, the fastener 66 is a double-sided tape having a suitable adhesion to ensure a durable coupling of the outer belt molding 38 to the door panel 48. The tape 66 is shown positioned between the outer segment of the main body 44 and the door panel 48. It is, however, contemplated that the tape 66 could be located in any of numerous locations to effect the attachment between the outer belt molding 38 and the door panel 48.

Referring to FIGS. 7 through 9, a fastener 68 in additional embodiments of the invention is a clip that is connected to the main body 42 and extends through an aperture 70 formed in the door panel 48. It is, however, appreciated that the fastener 68 may be any of numerous structural members for connecting the mounting portion 44 to the door panel 48.

Referring to FIG. 7, the clip 68, which is formed from a plastic material, is attached to the outer segment 52 of the main body 42 via heat staking. The clip 68 extends through the aperture 70 formed in the door panel 48 to secure the outer belt molding 38 to the door panel 48.

Referring to FIG. 8, the clip 68 in an alternative embodiment is co-extruded with the main body 42 and notch cut into shape. The clip 68 is preferably formed from TPV but it is appreciated that the clip 68 may be formed from any of numerous materials.

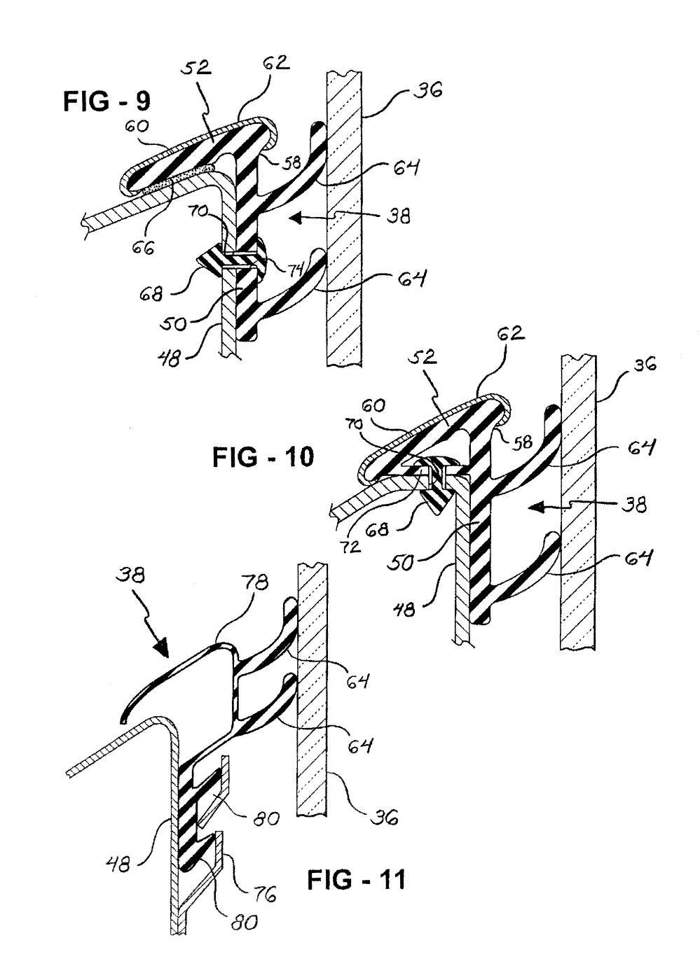

Referring to FIG. 9, the clip 68 in another alternative embodiment extends through the vertical segment 50 of the main body 42 and through the aperture 70 formed in the door panel 32. It is appreciated that this the clip 68 may extend through any portion of the main body 42 that aligns with the aperture 70 formed in the door panel 48.

Referring to FIG. 10, the outer belt molding 38 in yet another embodiment includes a web portion 72 extending between one end of the outer segment 52 and the vertical segment 50. The web portion 72, which is preferably formed from TPV, defines an aperture 74. The clip 68 extends through the aperture 74 and the corresponding aperture 70 in the door panel 48 to secure the outer belt molding 38 to the door panel 48. The tape 66 is also utilized along the web portion 72 to further secure the web portion 72 to the door panel 48.

Referring to FIG. 11, in another embodiment of the invention, a retention tab 76 is welded or otherwise secured to the door panel 48. The outer belt molding 38 includes a carrier 78 formed from a metal, preferably stainless steel. A plurality of retention members 80 is disposed along the carrier 78 for sealingly engaging the retention tab 76 to secure the outer belt molding 38 to the door panel 48. The plurality of retention members 80 is preferably formed from TPV. It is, however, appreciated that the retention members 80 may be formed from any of numerous materials.

In each of the above-described embodiments, the outer belt molding 38 has a low profile that is consistent with providing the motor vehicle door 32 with an aesthetically pleasing appearance. In addition, the decorative trim 62 complements the appearance of the motor vehicle door 32.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. An outer belt molding for a door panel of a motor vehicle door, said outer belt molding comprising:
an elongated main body adapted to be attached to the door panel along a lower edge of a window opening, said elongated main body having a mounting portion; and
a fastener coupled to said mounting portion and extending through a corresponding aperture in the door panel to fixedly secure said outer belt molding to the door panel.

2. An outer belt molding as set forth in claim 1 wherein said main body defines an opening aligned with the aperture in the door panel for receiving said fastener therethrough.

3. An outer belt molding as set forth in claim 1 wherein said mounting portion includes a generally vertical segment having opposing door panel and window pane facing surfaces.

4. An outer belt molding as set forth in claim 1 wherein said fastener is a clip extending out from said mounting portion and extending through the corresponding aperture in the door panel.

5. An outer belt molding as set forth in claim 1 including a sealing portion for sealingly engaging a window pane selectively closing the window opening.

6. An outer belt molding as set forth in claim 3 wherein said vertical segment defines an opening extending through said door panel and window facing surfaces for receiving said fastener to fixedly mount said mounting portion along the door panel.

7. An outer belt molding as set forth in claim 3 wherein said mounting portion includes an outer segment extending out from said vertical segment and abutting the door panel surface.

8. An outer belt molding as set forth in claim 7 including a decorative trim fixedly secured to an outboard surface of said outer segment.

9. An outer belt molding as set forth in claim 5 wherein said mounting portion includes a web portion extending between said vertical segment and said outer segment.

10. An outer belt molding as set forth in claim 9 wherein said fastener extends through the web portion and the aperture in the door panel.
